(19) United States
(12) Patent Application Publication
(10) Pub. No.: US 2022/0255762 A1
(43) Pub. Date: Aug. 11, 2022

(54) LIFECYCLE CHANGE CRYPTOGRAPHIC LEDGER

(71) Applicant: Hewlett-Packard Development Company, L.P., Spring, TX (US)

(72) Inventor: Rafael Dal Zotto, Porto Alegre (BR)

(73) Assignee: Hewlett-Packard Development Company, L.P., Spring, TX (US)

(21) Appl. No.: 17/629,803

(22) PCT Filed: Sep. 27, 2019
(86) PCT No.: PCT/US2019/053397

§ 371 Date: Jan. 25, 2022

(51) Int. Cl. H04L 9/00

(52) U.S. Cl. CPC H04L 9/50

(57) ABSTRACT

In an example implementation according to aspects of the present disclosure, a system comprising a memory, a storage medium, and a processor communicatively coupled to both the memory and the storage medium. The system receives a lifecycle change event, wherein the lifecycle change event corresponds to a component change in a unit. The system updates a first distributed cryptographic ledger with a first entry corresponding to the component indicating the lifecycle change. The system updates a second distributed cryptographic ledger with a second entry corresponding to the unit indicating the lifecycle change. The system transmits the first entry and the second entry to a plurality of nodes, wherein the nodes validate the first entry and the second entry.

### BACKGROUND

Computing devices including personal computers often utilize multiple components. During the life time of the personal computer subcomponents may be replaced or interchanged.

### BRIEF DESCRIPTION OF THE DRAWINGS

FIG. 1 is a block diagram illustrating a system for supporting a lifecycle change cryptographic ledger, according to an example;

FIG. 2A is a block diagram illustrating a plurality of lifecycle change cryptographic ledger, according to an example;

FIG. 2B is a block diagram illustration of an entry in the lifecycle change cryptographic ledger, according to another example;

FIG. 3 is a flow diagram illustrating a method for updating a lifecycle change cryptographic ledger, according to an example; and

FIG. 4 is a computing device for supporting a lifecycle change cryptographic ledger, according to an example.

### DETAILED DESCRIPTION

When end-consumer purchases computing devices (printers, notebooks, workstations, etc.) for devices utilizing a device as a service (DaaS) DaaS approach, over time components of those devices can deteriorate and/or start to present problems. When this happens, specific components are exchanged/replaced by new ones or by existent ones, that were replaced from other devices.

In this common scenario and with the current approaches, it may be near to impossible to consistently track the historical information for each computing device and/or component. Every time a device component is replaced, re-use of the component in another device or the sale of the component, represents a lifecycle event. In addition to this problem, computing devices and components of the computing devices that become irresponsive or ‘dead’ are impossible to be understood, from an overall historical point of view, without having the disassembly of its components. Even doing this retrieving the details for the components may be difficult.

The disclosure described herein presents a system and a method that allows tracking the lifecycle events of a computing device using blockchain. With the solution described within this document, end-users will be able to have access to their computing device's lifecycle; from the moment it was manufactured to the time it was acquired. Similarly, fleet managers will be able to access computing devices and their respective component historical details even for devices that are turned off or no longer responsive. Likewise, an individual component may have a comprehensive lifecycle event history stored and retrievable in the blockchain so that a fleet manager can inspect a component to determine whether the component is acceptable for a purpose based on its lifecycle event history.

Additionally, this approach allows for quick inspection of a component or unit's lifecycle history from a graphical user interface (GUI). The GUI may reside on an separate computing device, such as a mobile device or smart phone. The GUI may interface with the blockchain, parsing the blocks, and creating a visual representation of the lifecycle event history. The visual representation may give fleet manager or information technologists a quick high level view, with an option to drill down, of the unit or component in question.

In one example, a unit blockchain comprises a plurality of component blockchain entries. The blockchain entries correspond to a plurality of constituent components and changes to those components. Each block on the unit blockchain may be a lifecycle change corresponding to a lifecycle change of a component. A component within the unit may include a hardware or software change. A hardware change may include the replacement, failure, or detectable degradation of the hardware. A software change may include the installation, removal, failure, or update of a piece of software within the unit. Components may also be combinations of hardware and software components. For example, an installed piece of hardware such as a network adapter may also have a corresponding software device driver with a specific version. The combination of the network adapter and the versioned device driver may be a component.

Lifecycle events should be understood as generic chunks of information that describe the computing device and underlying components at a given moment in time. For example, following DaaS as an example: based on the collected telemetry data, each computing device and underlying components may be graded based on their usage and how they are performing over time. The grades (both for the device as well as for the components) change and variations may be understood as lifecycle events. The act of replacing a given component is a lifecycle change event, both for the unit but also for the component. Likewise the lifecycle change event may correspond to a state change event. For example, some components may have internal error detection which provides warning prior to failure. These components may change state and operate in a degraded performance mode to increase longevity and provide alert prior to failure.

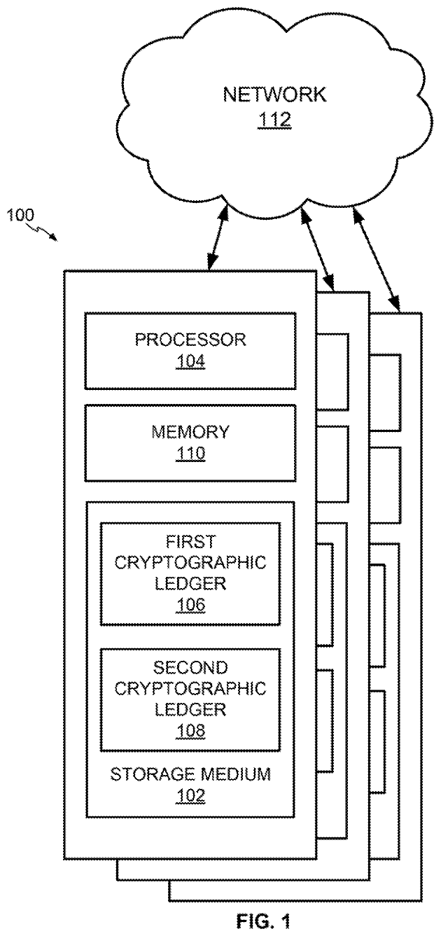

FIG. 1 is a block diagram illustrating a system 100 for supporting a lifecycle change cryptographic ledger, according to an example. The system 100 may include a processor 104, memory 110, and a storage medium 102. Each system 100 may create a node. Within each node may be a first distributed cryptographic ledger 106 and a second distributed cryptographic ledger 108. FIG.1 is illustrated for simplicity in showing only the first distributed cryptographic ledger 106 and a second distributed cryptographic ledger 108. In one implementation, the system 100 may utilize more than two cryptographic ledgers. There is not upper limit on the number of cryptographic ledgers that may be utilized to realize the system 100. In one example, the first distributed cryptographic ledger 106 and second distributed cryptographic ledger 108 may be implemented as blockchain. Each entry within the first distributed cryptographic ledger 106 and second distributed cryptographic ledger 108 may be referred to as a block.

First distributed cryptographic ledger 106 and the second distributed cryptographic ledger 108 may be implemented at a set of logical blocks forming a distributed database implemented on the storage medium 102. The storage medium 102 may be a persistent memory subsystem for a computing device that the processor 104 may access. Examples of the storage medium 102 may include abut are not limited to mechanical hard disk drive (HDD), a solid state drive (SSD), and non-volatile memory (NVM).The first distributed cryptographic ledger 106 and the second distributed cryptographic ledger 108 may maintain a continuously-growing list of records in the logical blocks. The blocks may be secured from tampering and revision due to their immutable properties. Each block contains a timestamp and a link to a previous block. The first distributed cryptographic ledger 106 and the second distributed cryptographic ledger 108 may be used to hold, track, transfer and verify any information. Because the first distributed cryptographic ledger 106 and the second distributed cryptographic ledger 108 may be implemented in a distributed system, prior to the addition of a transaction to the either the first distributed cryptographic ledger 106 and the second distributed cryptographic ledger 108 ledger, all nodes need to reach a consensus status.

The first distributed cryptographic ledger 106 and the second distributed cryptographic ledger 108 may be implemented as a composite blockchain structure that allows keeping track of lifecycle events and overall degradation of computing devices and the corresponding individual components. Blocks of data may be maintained containing important information for each unit. Considering that computing devices may include the components, a composite approach where each block holds a reference to a collection of additional blocks, that relates specifically to the lifecycle of a specific component

A network 112 facilitates transfer of the blocks of the first distributed cryptographic ledger 106 and the second distributed cryptographic ledger 108 between many nodes with duplicated data. The network 112 may be implemented as a wide area network, local area network, or the internet. The network 112 may utilize wired or wireless connections to support the transfer of the blocks between the nodes hosting the first distributed cryptographic ledger 106 and the second distributed cryptographic ledger 108.

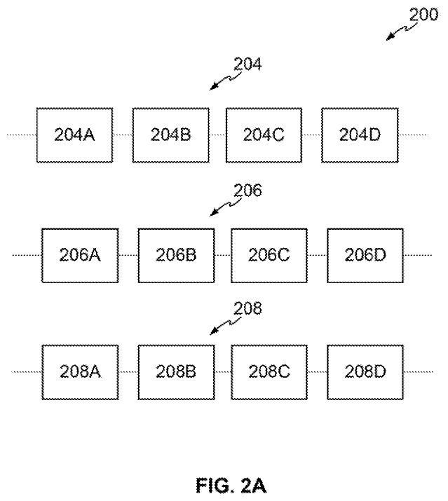

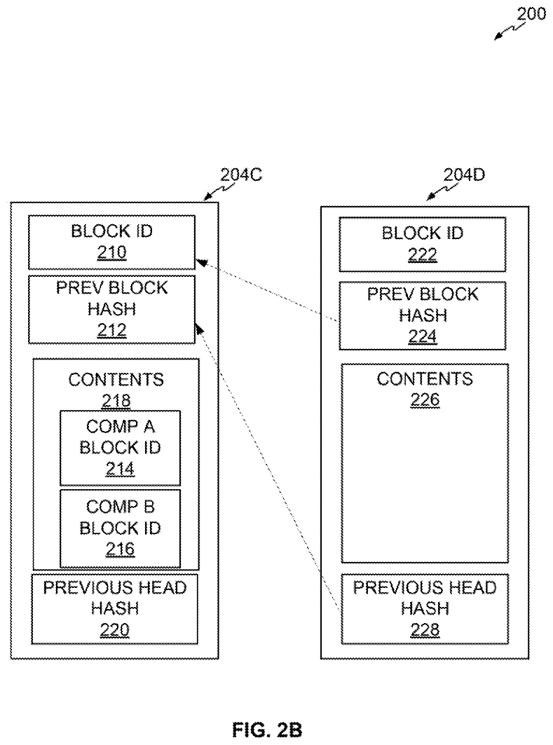

FIG. 2A is a block diagram 200 illustrating a plurality of lifecycle change cryptographic ledger, according to an example.

In this diagram, at the highest level may be the unit blockchain 204. Referring back to FIG. 1, the unit blockchain 204 may be the implementation of the first distributed cryptographic ledger 106. Within the unit blockchain 204 may be unit blocks 204A, 204B, 204C, 204D. The unit blocks 204A, 204B, 204C, 204D may each correspond to a lifecycle change even for the unit or computing device. As mentioned previously, a lifecycle change event may include a hardware modification, a software modification, or a combination hardware and software modification.

Component A blockchain 206 and component B blockchain 208 may serve as an aggregate part of the unit blocks 204A, 204B, 204C, 204D corresponding to unit blockchain 204. Component A blocks 206A, 206B, 206C, 206D correspond to lifecycle changes to component A and are registered as component A blocks in the ledger of the component A blockchain 206. Likewise, component B blocks 208A, 208B, 208C, 208D correspond to lifecycle changes to component B and are registered as component B blocks in the ledger of the component B blockchain 208.

FIG. 2B is a block diagram illustration of an entry in the lifecycle change cryptographic ledger, according to another example. FIG. 2B makes references to features identified in FIG. 2A.

Unit block 204C and unit block 204D are displayed in more detail in FIG. 2B. Unit block 204C may include a block ID 210, a previous block hash 212, contents 218 and a previous head hash 220. The contents 218 may further include component A block ID 214, and component B block ID 216. The features of unit block 204C may provide underlying functionality for establishing and securing the blockchain corresponding to the first distributed cryptographic ledger 106. The block ID 210 may be the unique identifier corresponding not only to unit block 204C, but also the corresponding lifecycle change event. In some implementations the block ID 210 may be a universally unique identifier (UUID). The previous block hash 212 may provide the UUID corresponding to the previous block in the blockchain or previous entry in the respective cryptographic ledger. The previous block hash 212 corresponds to the previous lifecycle event. Not illustrated in FIG. 2B directly, since previous block hash 212 references the previous block in the blockchain, it can be inferred from FIG. 2A and FIG. 2B that previous block hash 212 would reference the block id of unit block 204B.

Previous head hash 220 may be a tamper detection security field. At the time unit block 204C is instantiated, previous head hash 220 may be created by hashing portions or the whole of the previous block referenced by previous block hash 212. By hashing portions or the whole of the previous block, and storing the resulting hash in a subsequent block, the integrity of the data of the entire blockchain may be secured as each block secures and is secured by other blocks in the blockchain.

Likewise, to the creation of unit block 204C and 204D, blocks corresponding to the components represented in component A blockchain 206 and component B blockchain 208 may be created. As they are created, blocks in component A blockchain 206 and component B blockchain 208 include a corresponding block ID. Therefore, component A blocks 206A, 206B, 206C, 206D and component B blocks 208A, 208B, 208C, 208D may be referenced by their block IDs. Returning to FIG. 2B, these respective block IDs may be referenced as component block A block ID 214 and component B block ID 216 within the contents 218 of unit block 204C. The contents 218 may also contain relevant information to identify and describe the component or unit including but not limited to serial numbers, part number, and last known operation state. These component block IDs correspond to lifecycle change events of the components related to the lifecycle change event of the unit. Corresponding components for a lifecycle change event may be stored in the contents.

Likewise, previous and subsequent blocks have the same fields. For example, unit block 204D includes a block ID 222, a previous block hash 224 that refers to block ID 210 of unit block 204C, and a previous head hash 228 corresponding to the contents of unit block 204C. The contents 226 are not illustrated as FIG. 2B shows a relationship between blocks and would unnecessarily complicate the diagram.

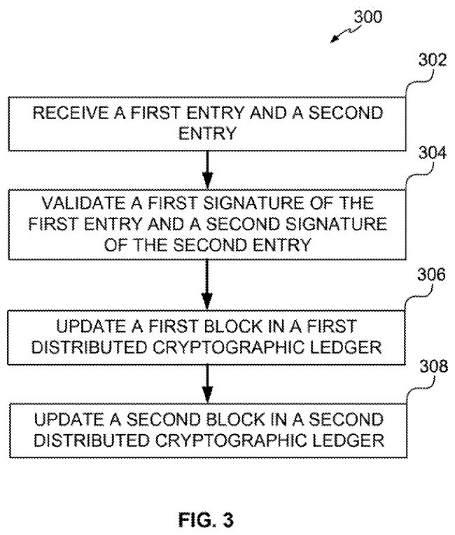

FIG. 3 is a flow diagram illustrating a method for updating a lifecycle change cryptographic ledger, according to an example. The processor 104 may receive the entries from a telemetry tool executing also on the processor 104. The telemetry tool may detect a lifecycle change event and interface the first and second distributed cryptographic ledger's application programmer interface (API) to interface with the implementation of the ledgers. The API provides the interface to create the blocks with the content to identify the component or unit. On the local processor 104, all blocks may be added to their blockchains. The newly created blocks may be transmitted to nodes for their corresponding blockchains.

At 302, the processor 104, receives a first entry and second entry from a transmission. The first and second entry are received and identified as belonging to their respective blockchains.

At 304, the processor 104, validates a first signature of the first entry to a first distributed cryptographic ledger and a second signature of the second entry to a second distributed cryptographic ledger. The processor 104 validates a hash value (e.g., previous head hash 220 FIG. 2B) to validate that integrity of the blockchain and the received, block/entry.

At 306, the processor 104, updates a first block in the first distributed cryptographic ledger, wherein the first distributed cryptographic ledger corresponds to a unit, with the first entry corresponding to a component indicating a lifecycle change for the unit. The processor 104 updates the blockchain by allocating a block for the new entry, inserts the block, and updates any respective fields corresponding to the blockchain.

At 308, the processor 104, updates a second block in the second distributed cryptographic ledger with the second entry corresponding to a unit indicating the lifecycle change. Likewise, the processor 104 updates the second distributed cryptographic ledger in a manner similar to the first. The processor 104 updates the blockchain in a similar manner, thereby preserving a record of the lifecycle change event for a component.

The processor 104 may evaluate a history of lifecycle change events in the first distributed cryptographic ledger. Since the first cryptographic ledger contains a history of the lifecycle of a computing device, the processor 104 may be used to execute logic upon the insertion of a new block into the first cryptographic ledger. In some implementations, the logic executed may be a smart contract. Smart contracts may be a feature of the blockchain selected to implement the first cryptographic ledger.

The processor 104 may determine whether the history including newly added block information meets a predetermined state and may evaluate a rule based on the determining. The logic may evaluate a history of the lifecycle change events to determine nuance in corresponding to the computing device that otherwise may not be visible. For example, the first distributed cryptographic ledger may include blocks indicating a history of changing out a random-access memory (RAM) card. The RAM may have been replaced three times within a given time period. The logic may execute on the insertion of a block corresponding to the lifecycle change event of the third memory exchange. The logic or smart contract may propagate an alert message to a user monitoring the first distributed cryptographic ledger. The logic executing on the predetermined state may also be applicable to the second distributed cryptographic ledger. In another example, the lifecycle change event for a RAM card indicates that it has been removed and added to different computing devices five times. In this example, five may be the threshold for which an event is triggered to remove that RAM card out of circulation as the history indicates that it may have an non-obvious issue.

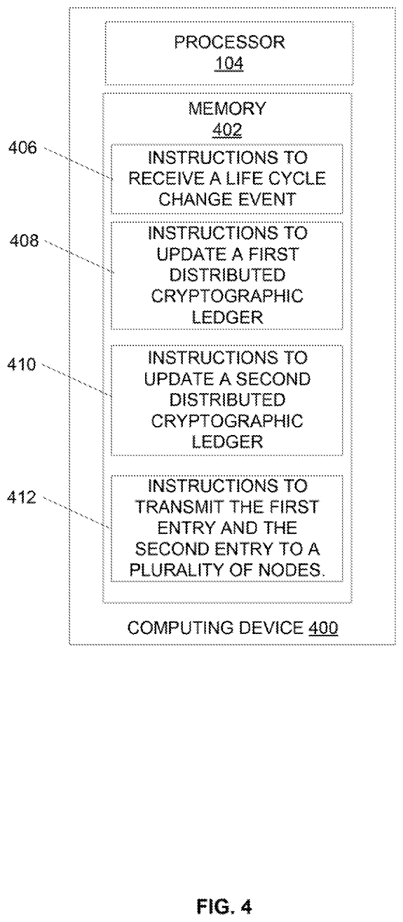

FIG. 4 is a computing device 400 for supporting a lifecycle change cryptographic ledger, according to an example.

The computing device 400 depicts a processor 104 and a memory 402 and, as an example of the computing device 400 for geospatial display configuration, the memory 402 may include instructions 406-412 that are executable by the processor 104. The processor 104 may be synonymous with the embedded processors found in common computing environments including central processing units (CPUs). In another implementation the processor 104 may be an embedded microcontroller for processing inputs. The memory 402 can be said to store program instructions that, when executed by processor 104, implement the components of the computing device 400. The executable instructions may correspond to computer implemented instructions corresponding to the method of FIG. 3. The executable program instructions stored in the memory 402 include, as an example, instructions to receive a lifecycle change event in memory 406, instructions to update a first distributed cryptographic ledger 408, instructions to update a second distributed cryptographic ledger 410, and instructions to transmit the first entry and the second entry to a plurality of nodes 412.

Memory 402 represents generally any number of memory components capable of storing instructions that can be executed by processor 104. Referring to FIG. 1, memory 402 may implement the storage medium 102. Memory 402 is non-transitory in the sense that it does not encompass a transitory signal but instead is made up of at least one memory component configured to store the relevant instructions. As a result, the memory 402 may be a non-transitory computer-readable storage medium. Memory 402 may be implemented in a single device or distributed across, devices. Likewise, processor 104 represents any number of processors capable of executing instructions stored by memory 402. Processor 104 may be integrated in a single device or distributed across devices. Further, memory 402 may be fully or partially integrated in the same device as processor 104, or it may be separate but accessible to that device and processor 104.

In one example, the program instructions 406-412 can be part of an installation package that, when installed, can be executed by processor 104 to implement the components of the computing device 400. In this case, memory 402 may be a portable medium such as a CD, DVD, or flash drive, or a memory maintained by a server from which the installation package can be downloaded and installed. In another example, the program instructions may be part of an application or applications already installed. In another example, the memory 402 may be internal flash memory to an input device, wherein the program instructions 406-412 may be installed from the input device manufacturer. Here, memory 402 may include integrated memory such as a flash ROM, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a memory;
a storage medium;
a processor communicatively coupled to the memory and the storage medium and configured to:
receive a lifecycle change event in the memory wherein the lifecycle change event corresponds to a component change in a unit;
update a first distributed cryptographic ledger in the storage medium with a first entry corresponding to the component indicating the lifecycle change;
update a second distributed cryptographic ledger in the storage medium with a second entry corresponding to the unit indicating the lifecycle change; and
transmit the first entry and the second entry to a plurality of nodes, wherein the nodes validate the first entry and the second entry.

2. The system of claim 1 wherein the first distributed cryptographic ledger entry comprises a reference to the second distributed cryptographic ledger entry.

3. The system of claim 2 wherein the component change comprises a state change of the component.

4. The system of claim 3 the processor further configured to:
evaluate a history of lifecycle change events in the first distributed cryptographic ledger;
determine whether the history meets a predetermined state; and
evaluate a rule basted on the determining.

5. The system of claim 1 wherein the first distributed cryptographic ledger comprises a plurality of entries corresponding to plurality of constituent components.

6. A method comprising:
receiving a first entry and second entry from a transmission;
validating a first signature of the first entry to a first distributed cryptographic ledger and a second signature of the second entry to a second distributed cryptographic ledger;
updating a first block in the first distributed cryptographic ledger, wherein the first distributed cryptographic ledger corresponds to a unit, with the first entry corresponding to a component indicating a lifecycle change; and
updating a second block in the second distributed cryptographic ledger with the second entry corresponding to a unit indicating the lifecycle change.

7. The method of claim 6 wherein the first distributed cryptographic ledger entry comprises a reference to the second distributed cryptographic ledger entry.

8. The method of claim 7 wherein the component change comprises a state change of the component.

9. The method of claim 7 further comprising:
evaluating a history of lifecycle change events in the first distributed cryptographic ledger;
determining whether the history meets a predetermined state; and
evaluating a rule basted on the determining.

10. The method of claim 6 wherein the first distributed cryptographic ledger comprises a plurality of entries corresponding to plurality of constituent components.

11. A machine-readable storage medium comprising executable instructions, that when executed cause a processor to:
receive a lifecycle change event in the memory wherein the lifecycle change event corresponds to a component change in a unit;
update a first distributed cryptographic ledger in the storage medium with a first entry corresponding to the component indicating the lifecycle change;
update a second distributed cryptographic ledger in the storage medium with a second entry corresponding to the unit indicating the lifecycle change; and
transmit the first entry and the second entry to a plurality of nodes, wherein the nodes validate the first entry and the second entry.

12. The machine-readable storage medium of claim 11 wherein the first distributed cryptographic ledger entry comprises a reference to the second distributed cryptographic ledger entry.

13. The machine-readable storage medium of claim 12 wherein the component change comprises a state change of the component.

14. The machine-readable medium of claim 13 further comprising instructions that when executed cause the processor to:
evaluate a history of lifecycle change events in the first distributed cryptographic ledger;
determine whether the history meets a predetermined state; and
evaluate a rule basted on the determining.

15. The machine-readable storage medium of claim 11 wherein the first distributed cryptographic ledger comprises a plurality of entries corresponding to plurality of constituent components.
